(19) United States
(12) Patent Application Publication
(10) Pub. No.: US 2013/0080900 A1
(43) Pub. Date: Mar. 28, 2013

(54) TECHNIQUES FOR MANAGING AND VIEWING FOLLOWED CONTENT

(71) Applicants: Benjamin Wilde, Quincy, MA (US); Donna Shaw, Andover, MA (US); Michael Jeffers, Boston, MA (US); Matthew Anderson, Tewksbury, MA (US)

(72) Inventors: Benjamin Wilde, Quincy, MA (US); Donna Shaw, Andover, MA (US); Michael Jeffers, Boston, MA (US); Matthew Anderson, Tewksbury, MA (US)

(73) Assignee: MICROSOFT CORPORATION, Redmond, WA (US)

(21) Appl. No.: 13/247,000

(22) Filed: Sep. 28, 2011

(51) Int. Cl. G06F 15/177

(52) U.S. Cl. 715/736

(57) ABSTRACT

Techniques to view and manage followed content are described. A technique may include receiving a selection to follow a content item. A reference to a content item selected for following may be stored for a user. The references for the user may be displayed in a centralized location in a user interface. The display may include contextual information about each followed content item with its reference. Additional information and functions for a followed content item may be displayed in response to a received selection for additional information. Other embodiments are described and claimed.

### BACKGROUND

Various mechanisms exist to enable a user to follow or return to a content item on a network. For example, web browsing applications provide a bookmark feature to store the uniform resource locator (URL) of an Internet web site. Social networking applications may allow a user to follow or “like” other individuals and content within the social networking site as well as content found on external websites. These and other mechanisms may make it difficult to view information about the followed content easily and efficiently. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques for managing and viewing followed content. Some embodiments are particularly directed to techniques for managing and viewing followed content of different types from a centralized location. In one embodiment, for example, a technique may include receiving a selection to follow a content item. A reference, such as a link, to followed content items may be stored for a user. The references to the followed content items may be displayed in a centralized location in a user interface, with contextual information about each followed content item. When a selector, e.g. a mouse pointer, is detected in proximity to a displayed reference, additional information and functions for the followed content item may be displayed. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a system for managing and viewing content.

FIG. 2 illustrates an embodiment of a collection manager.

FIG. 3 illustrates an embodiment of a first user interface.

FIG. 4 illustrates an embodiment of a second user interface.

FIG. 5 illustrates an embodiment of a third user interface.

FIG. 6 illustrates an embodiment of a fourth user interface.

FIG. 7 illustrates an embodiment of a logic flow.

FIG. 8 illustrates an embodiment of a computing architecture.

FIG. 9 illustrates an embodiment of a communications architecture.

### DETAILED DESCRIPTION

Conventional content-following mechanisms, such a browser bookmarks, may not transfer well among different devices for a particular user. Some mechanisms, such as bookmarks, may not provide context about the content beyond a link to the content. Some mechanisms, such as social networking “following” and “liking” may make it difficult to manage and locate the followed content.

Various embodiments are directed to techniques for managing and viewing followed content across one or more networks. Various different types of content may be followed, for example, web sites, word processing documents, presentation documents, spreadsheet document, other documents, calendar events, discussions on a discussion board, conversations, tasks, lists, libraries, really simple syndication (RSS) feeds, another person's social network feed or page, and so forth. When a particular user selects a content item to follow, embodiments may generate and/or store a reference to the content item. The reference may be associated with the particular user. The references to a particular user's followed content may be displayed in one centralized location in a user interface regardless of the source of the content. In this way the user may quickly access the followed content from one location, rather than having to navigate among, for example, a browser bookmark menu, a social networking site, and a document sharing service.

In addition to displaying the references to the followed content, embodiments may also display contextual information about each followed content item. For example, contextual information may include the title of the content item, a date the content item was followed, whether the content item has been updated within a time frame, an address or location of the content item, an author of the content item, a preview of the content item, an icon, a type, a date modified, a keyword, an editor, a commenter and so forth. In an embodiment, the display of references may be sorted and/or filtered according to some or all of the contextual information.

Embodiments may also provide additional information about a followed content when the user places a selector, such as a cursor or pointer, near or on the displayed reference. For example, additional information may include a preview, a modification notice, when a last edit was made, who made the last edit, conversations about the content item. The additional information may be provided, for example, in a call-out window, a pop-up window, or in an expanded display area for the reference in question. The additional information may reflect actions that are currently occurring to the content item. Options for additional functions may be displayed with the additional information. For example, the ability to manage notifications about updates for a content item may be accessed from the additional information. Other functions may include opening the content item, and adding a comment to the content item.

Some embodiments may allow a first user to share followed content with others in a public display of the followed content references. A second user viewing the first user's public display may be able to follow the displayed content from that display, and see what content the second user is already following. As a result, the embodiments can improve the user experience and efficiency in viewing and managing followed content.

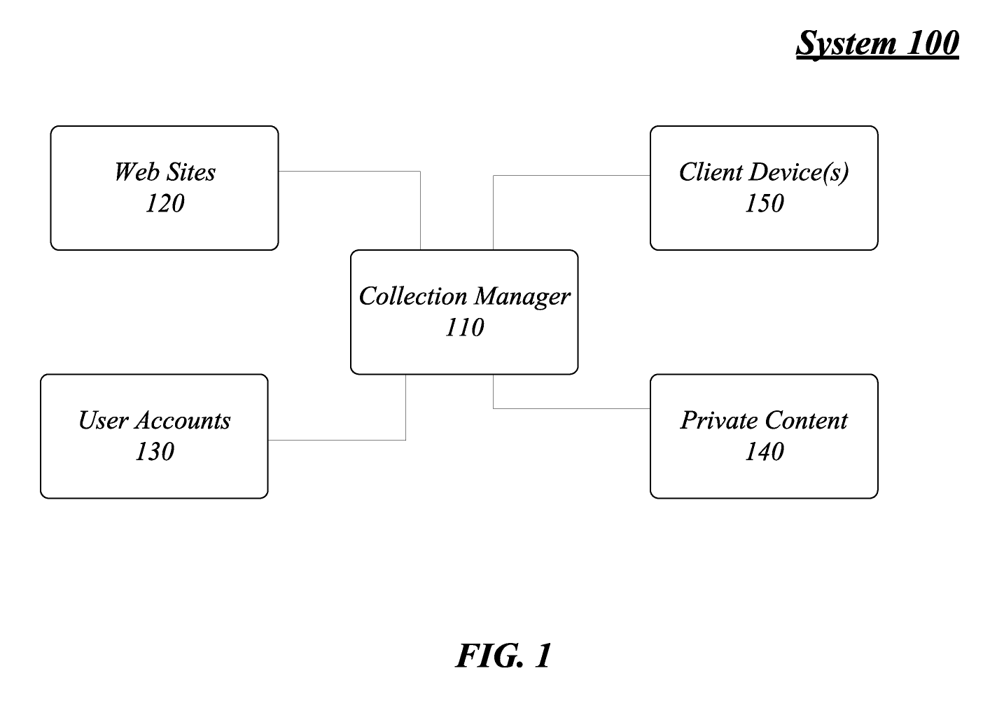

FIG. 1 illustrates a block diagram for a system 100 to view and manage followed content. In one embodiment, for example, the system 100 may comprise a computer-implemented system 100 having multiple components, such as a collection manager 110, and a client device 150. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented with one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

System 100 may include collection manager 110, which may be in communication with web sites 120, user accounts 130 and a client device 150. System 100 may further include private content 140, such as data stored within a private network, e.g. a business intranet, or on a secure server. In an embodiment, collection manager 110, user accounts 130 and private content 140 may all be components of a business entity's network. Alternatively, collection manager 110 may stand alone as a followed content management application and service.

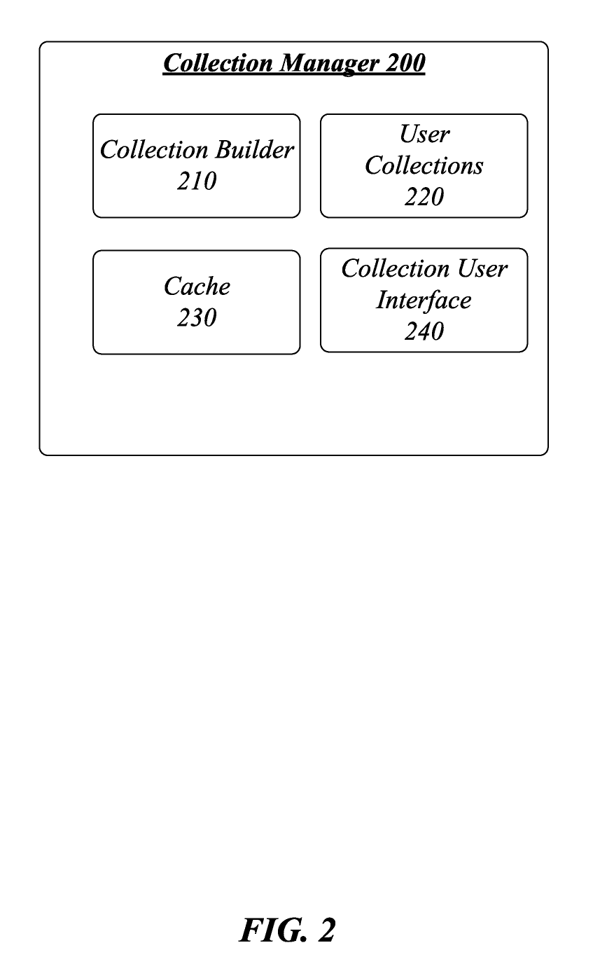

In various embodiments, collection manager 110 may receive a selection of one or more content items that a user has chosen to follow. Collection manager 110 may store references to the followed content for the user. Collection manager 110 may also cache information about the followed content, for example, information about when the content is modified or followed. Collection manager 110 may provide a user interface to display the references to the user in one centralized location. Content manager 110 may provide the reference information to a separate user interface, for example, through a content generating application or a web browser. Content manager 110 is discussed further with regard to FIG. 2.

A web site 120 may comprise a network server implementing a web site hosting application, a web browser, or other suitable application for serving content to clients, such as a client device 150. A web site may include one or more web pages of text, images, video, audio, hyperlinks, and/or other content types formatted to be viewed in an application such as a web browser, for example, Internet Explorer by Microsoft Corp., Safari by Apple Inc., or Chrome by Google. The pages may include, for example, hypertext markup language (HTML) coded pages, extensible markup language (XML) coded pages, JAVA applets, plain text, and so forth, or a combination thereof. Web sites 120 may include external web sites, e.g. those generally accessible via the Internet, and internal web sites, such as those provided on a company intranet and are not accessible without proper credentials outside of the intranet. In an embodiment, web sites 120 may also include publically accessible content items other than web pages.

User accounts 130 may include information to identify users uniquely for collection manager 110. User accounts 130 may be, for example, part of an employee database for a business. User accounts 130 may be accounts established for the sole purpose of managing followed content, or may be accounts for social networking sites, internet service, and so forth. The information may include, for example, a unique user identifier and some form of authentication, such as a password or encrypted key. Collection manager 110 may use user accounts 130 to associate a stored reference for the user that selected the content to follow, and to retrieve the stored references for a user when the user views the references to the followed content.

Private content 140 may include data that is stored or accessed from a private network, such as a business or government intranet. The data may include documents, libraries, contact information, calendar information, tasks, projects, business data and so forth. In some embodiments, the private content 140 may be shared and modified in conjunction with a document management application or a collaboration application. Collection manager 110 may be a component of such a document management application or collaboration application. Private content 140 may include private data stored remotely, e.g. “in the cloud,” that is accessible to an authenticated user over a network.

Client devices 150 may include a wired or wireless computing device operating various applications, such as a browser, application viewer or other application program, suitable for receiving and displaying content items. Client devices 150 may receive and respond to control directives from a user, for example, input from an input device that causes a browser to connect to a specific website; a word processing application to open a file; the collection manager to follow a content item; and so forth. A client device 150 may be directly communicatively coupled to an intranet. A client device 150 may be communicatively coupled to an intranet via an external network. A client device 150 may communicatively coupled to an external network, e.g. the Internet, without being coupled to an intranet. The embodiments are not limited to these examples.

In various embodiments, the components of system 100 may all be components of a private network. In that case, collection manager 110 may manage followed content located within the private network. In other embodiments, the components of system 100 may all be accessible from a public network, such as the Internet. In still further embodiment, some of the components of system 100 may be within a private network, e.g. private content 140, collection manager 110 and user accounts 130, while the other components are external to the private network.

FIG. 2 illustrates a block diagram of a collection manager 200. Collection manager 200 may be a representative example of collection manager 110. Collection manager 200 may include one or more components or modules to provide the functionality described herein. In an embodiment, for example, collection manager 200 may include a collection builder 210, and a collection user interface 240. Collection manager 200 may additionally create and store user collections 220 and a cache 230. The embodiments are not limited to the type, number or arrangement of components illustrated in FIG. 2.

Collection builder 210 may receive an indication that a user would like to follow a content item. For example, while a document, web page, or other content item is open on a client device, a user may make a control directive with an input device to select a “follow” user interface component, e.g. a button or menu option. When that indication is received, collection builder 210 may copy the location of the content item. For example, if the content item is a web page, collection builder 210 may copy the URL of the web page. If the content item is a document, collection builder 210 may copy the directory address of the document. Collection builder 210 may generate a reference, such as a pointer or a hyperlink, to the content item. The reference may include the location, as well as some contextual information, such as a title, and the date when the content item was selected to be followed. Collection builder 210 may store the reference to the followed content item in a user collection 220. When a user indicates that he no longer wishes to follow a content item, collection builder 210 may remove the reference to that content item from the user collection 220.

A user collection 220 may be a set that includes a reference for each content item that a particular user is following. In an embodiment, collection manager 200 may maintain a separate user collection for each unique user that has a user account 130. A user collection 220 may be, for example, a list of references, a database table of references, a text document of references, and so forth.

Cache 230 may be a data store that contains information about a followed content item that has been modified in some way. When a content item is selected for following, collection builder 210 may indicate to the application related to the content item that the content item is being followed. When the content item is subsequently changed using the related application, information about the change may be stored in the cache for that content item. Information about the change may include, for example, that a change was made, the date of the change, the identity of the user that made the change, and so forth. In an embodiment, cache 230 may be used primarily for recent changes, and/or for small changes.

Collection user interface (UI) 240 may provide various user interface views for viewing and managing followed content. For example, collection UI 240 may provide several mechanisms by which a user may elect to follow or stop following a content item. In third-party applications, such as a web browser or other document viewing and editing application, collection UI 240 may provide a follow option as an add-on, e.g. a button in a tool bar, or an option in a contextual menu. When collection manager 110 is integrated with an application, such as within a collaboration application, the application may include collection UI 240 components to allow a user to follow or stop following a content item.

Collection UI 240 may provide a collection view in a central location, e.g. within one window or one application, where a user collection 220 may be displayed. The collection view may be analogous to a home page or a profile page in that the central location may display information relevant to a particular user somewhat like a news feed, and may be a launch point to view any of the content items that the user is following. The collection view may display some or all of the references in a user's collection. The references may include contextual information about the content item, such as location, type, author, editor, date created, date followed, keywords, and so forth. The display of references in the collection view may be sortable and filterable. For example, the references may be sorted by type, by title of the content item, by date, and so forth. The references may be filtered, for example, by date followed, author, type, and so forth.

Collection UI 240 may provide additional information and functions for a particular reference and content item when a pointer corresponding to an input device is detected in proximity to a reference. For example, when a pointer is near a reference, collection UI 240 may check cache 230 and/or go to the content item of the reference to obtain additional information about the content item. Additional information may include, for example, a preview, a modification notice, an edit date, an editor, a commenter, or conversations about the content item. Additional functions that may be provided may include opening the content item, managing notifications about the content item, starting a conversation, adding a comment to a conversation about the content item, filtering what additional functions to display, and sharing the content item with others.

Collection UI 240 may provide a public view of a user's collection. In an embodiment, a user may follow another user. Updates to one user's collection may appear in a following user's collection view. When one user views another user's public collection view, the public view may provide options to follow content directly from the public collection view, without the user having to open the content item first. The embodiments are not limited to these examples.

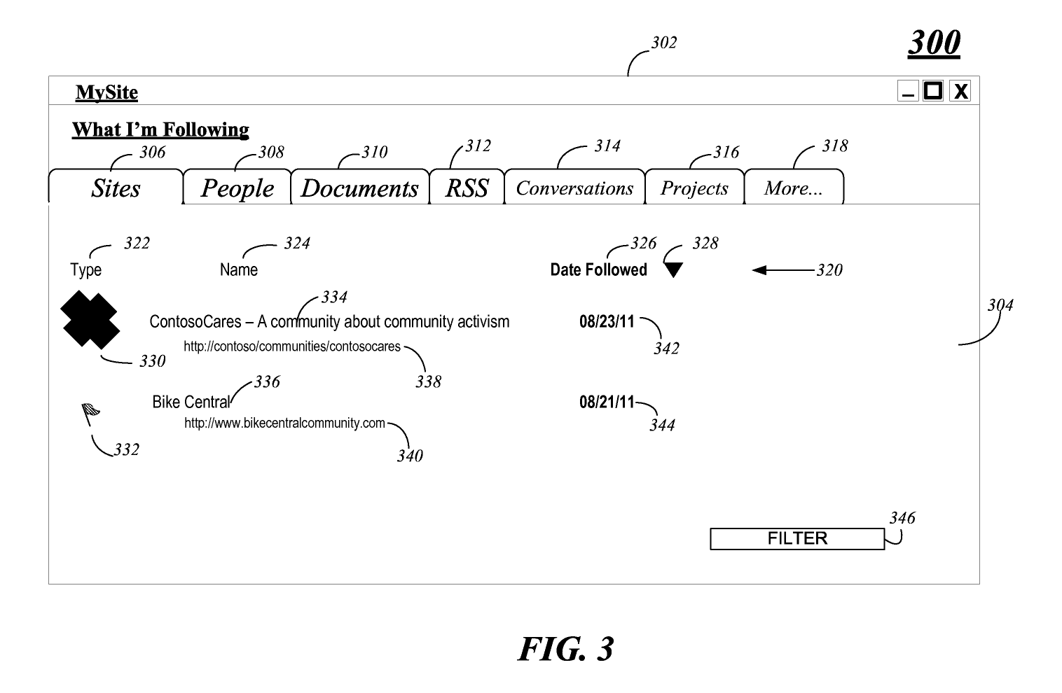

FIG. 3 illustrates an example of a collection view 300 according to embodiments. Collection view 300 may be an example of one of the user interface features provided by collection UI 240.

Collection view 300 may be provided in a bounded display area, such as window 302. Collection view 300 may include an information pane 304 where the references to the followed content and contextual information are displayed.

The followed content may be organized by kind, for example, into different tabbed panes such as sites 306, people 308, documents 310, RSS feeds 312, conversations 314, projects 316, and other kinds in more tab 318. Sites 306 may include internal and/or external web sites, e.g. HTML pages displayable in a web browser application. People 308 may include the public collections of other users having an account in user accounts 130. Documents 310 may include, for example, word processing documents, spreadsheets, videos, drawings, and so forth. RSS feeds 312 may include RSS feeds to which the user is subscribed. Conversations 314 may include, for example, bulletin board discussions, forum discussions, community discussion, comments about a content item and so forth. Projects 316 may include project plans and supporting documents. Additional kinds of content items may be included in more tab 318. More tab 318 may also be provided when the size of the display is not sufficient to present all of the tabs of content. Selecting more tab 318 in that embodiment may collapse some displayed tabs and open others, or may present the additional content kinds on one pane. The embodiments are not limited to these examples.

Collection view 300, as shown, is displaying content items of the kind “sites,” under site tab 306. The information shown about the followed sites in information pane 304 may include a header 320 to explain the information shown. For example, header 320 may include a type 322 field, a name 324 field, and a date followed 326 field. Header 320 may also indicate by which information field the content is sorted. In the illustrated example, the web site content items are sorted in descending order by date followed 326 field. This may be indicated, for example, by a different type face or formatting, e.g. bold or underlined text, and by an arrow 328 to indicate descending order. In an embodiment, a user may change what field to sort on, for example, by clicking on the relevant field in header 320.

The displayed references to the followed content items may include various forms of contextual information. In the illustrated embodiment, the contextual information for a followed content item may include a visual indication of its type or origin, for example, images 330 and 332. The visual indication may include, for example, a graphic, an icon, an image, a symbol and so forth. In the context of a website, visual indication of the type or origin may come from a graphic or symbol associated with the website, such as a corporate logo or symbol.

The contextual information may include a title, a name, or a short description, for example, titles 334 and 336. In an embodiment, the title may be a selectable hyperlink or reference that, when selected, opens the content item in the relevant application.

The contextual information may include a location or address where the content item is stored or accessible from, for example, URLs 338 and 340. In an embodiment, the location or address may not be an actual selectable link to the content item, and may instead be information that helps distinguish the content item from another content item that may be similarly titled. In an embodiment, the location or address may be selected and copied for pasting into other areas, such as documents and e-mail messages.

The contextual information may include the date that the content item was selected for following, for example, dates 342 and 344.

In an embodiment, collection view 300 may include a filter 346 operation. The filter operation may be provided, for example, as a menu option, a button, a writable field, or a combination of user interface elements. The references displayed in information pane 304 may be filtered on one or more of the fields of contextual information. For example, the references may be filtered by type, by date, by location, by keywords, e.g. in the title, and so forth. Selecting the filter 346 operation may present an interface (not shown) that allows the user to select or enter the information on which to filter. In an embodiment, an interface for filter operation 346 may be always available in collection view 300. The embodiments are not limited to these examples.

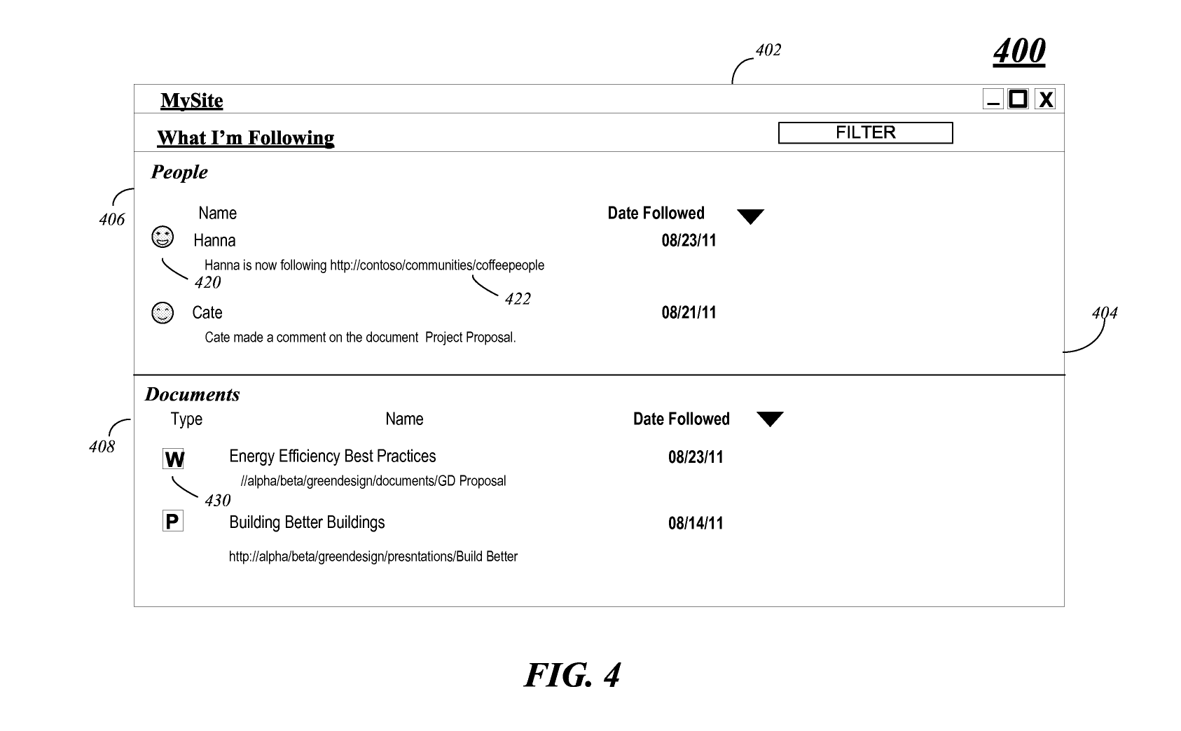

FIG. 4 illustrates an example of a collection view 400 according to embodiments. Collection view 400 is similar to collection view 300; however, instead of dividing the content among tabs, the different types of content are displayed together in the information pane 404 of window 402. The references to the different kinds of content may be grouped within the information pane by kind. In the illustrated example, people are shown in section 406, followed by documents in section 408. In an embodiment, all of the followed content of a kind may be displayed. Alternatively, a limited number of followed content kind may be displayed initially. When limited, the references that are displayed may be determined by criteria such as most recently modified or most recently followed. The number of references displayed may be determined, for example, as a fixed number, or according to space availability in information pane 404.

In an embodiment, the references may be displayed without being divided into kinds. The references may then be sorted by date followed, type, and so forth, as previously described.

In the illustrated example, a reference for a followed person may show, for example, an image 420 for the person in place of a type indication. Image 420 may be a photo, an avatar, or a team logo, for example. The person's name may be displayed, and a summary of the person's recent activity, e.g. summary 422. In an embodiment, a user may have the option to follow content item referenced in the followed person's reference. For example, the user viewing summary 422 may be able to place a selector near that reference to trigger a call-out window or contextual menu from which a follow option may be selected. A location for a person, if shown, may be a corporate site name, or a street address.

In the illustrated example, a followed document may display contextual information analogous to the contextual information displayed for a site. The type for a document may reflect the application of origin, for example, type 430 may indicate that the document is a word processing document. A location for a document may be a directory address. The embodiments are not limited to these examples.

As with collection view 300, collection view 400 may be filtered according to type, date followed, kind and so forth. Filtering may allow a user to locate a specific reference quickly when the user is following a large number of content items.

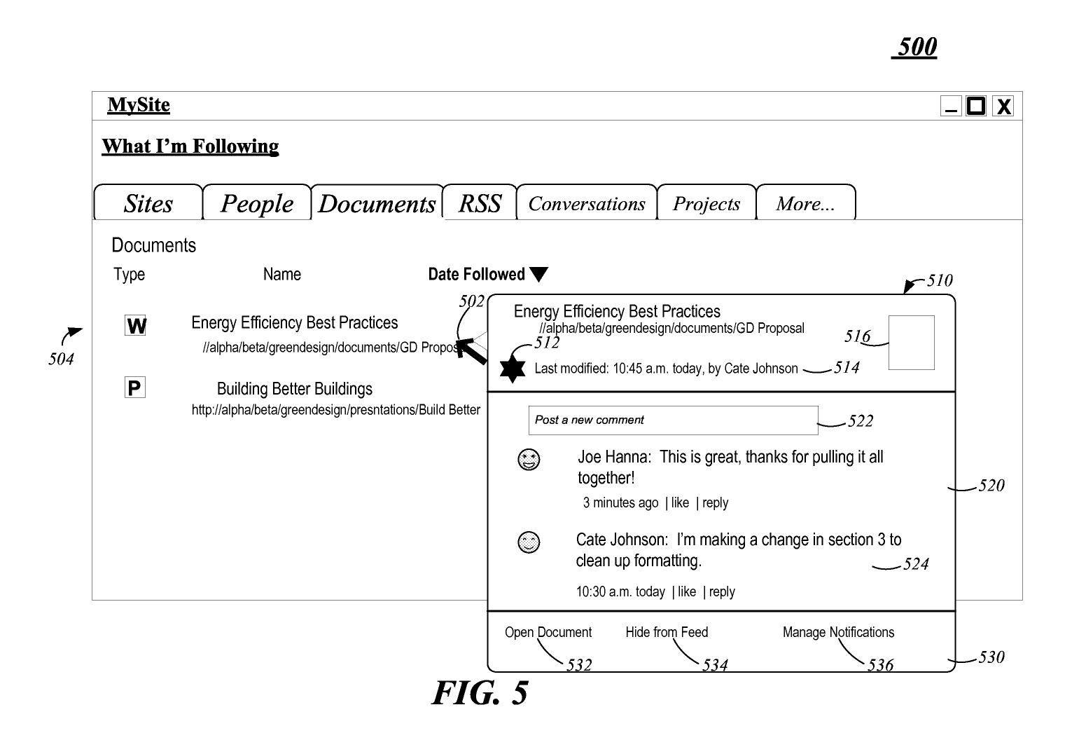

FIG. 5 illustrates an embodiment of a collection view 500 where additional information and functions appear for a specific reference. Collection view 500 may be similar to collection view 300, although with documents 310 selected instead of sites 306.

In the illustrated example, a selector, e.g. mouse pointer 502, is detected in proximity to a reference 504. In response, a call-out window 510 may be displayed. Call-out window 510 may include additional information about reference 504. For example, call-out window 510 may include, in addition to some of the contextual information from the reference, a visual indication 512 that the content item referenced by reference 504 has been modified within some time period. The time period may be, for example, since the last time the user viewed the reference, in the past day, since the last time that the user viewed the content item, and so forth.

Call-out window 510 may provide modification information 514 about the last time that the content item was modified, for example, the modification date and time, and who made the modifications.

Call-out window 510 may include a thumbnail image 516 of the document. In an embodiment, while call-out window 510 is open, a preview of the document (not shown) may be opened by moving the selector over thumbnail image 516. The preview may allow the user to zoom into the document and scroll through the document. Thumbnail image 516 may represent a scaled down image of the first page of the document, or a portion of a page of the document. The embodiments are not limited to these examples.

Call-out window 510 may provide a conversation pane 520. Conversation pane 520 may include the comments written and posted to the content item. Conversation pane 520 may provide an input field 522 to add a new comment. A comment, such as comment 524, may include the commenter's name, a graphic or photo of the commenter, the comment, a time/date stamp, and additional functions, such as “liking” and replying to the comment. In an embodiment, when a user “likes” a comment on a content item that the user is not currently following, the conversation and/or the content item may then be selected for following.

Call-out window 510 may provide an additional functions pane 530. Additional functions may provide operations related to the viewing and managing followed content within the context of viewing the references, and without making the user navigate to different user interfaces to manage the content. For example, additional functions pane 530 may include an option 532 to open the content item. This allows immediate access to the content item without having to navigate to a directory or to an application program to open the document. Additional functions pane 530 may include an option 534 to hide the content item from the feed. Option 534 allows the user to prevent the content item from appearing in the collection view, but may maintain the content item in the collection for the user. A hidden content item may be later revealed when an option such as “show hidden” is selected. Additional functions pane 530 may include an option 536 to manage notifications about the content item. Selecting option 536 may open another interface (not shown) that allows the user to choose various criteria on receiving notifications. For example, the user may be able to configure the type of notification, e.g. e-mail message, text message, visual indication in the collection view and so forth. The user may be able to configure under what circumstances to generate a notification, for example, when a new comment is made, when a modification is made, when another user chooses to follow the content item, and so forth. A function (not shown) may be provided to allow the user not to publish a reference to the content item in the user's public collection view. Other functions appropriate to the content kind may be provided in the call-out window without limitation. The embodiments are not limited to these examples.

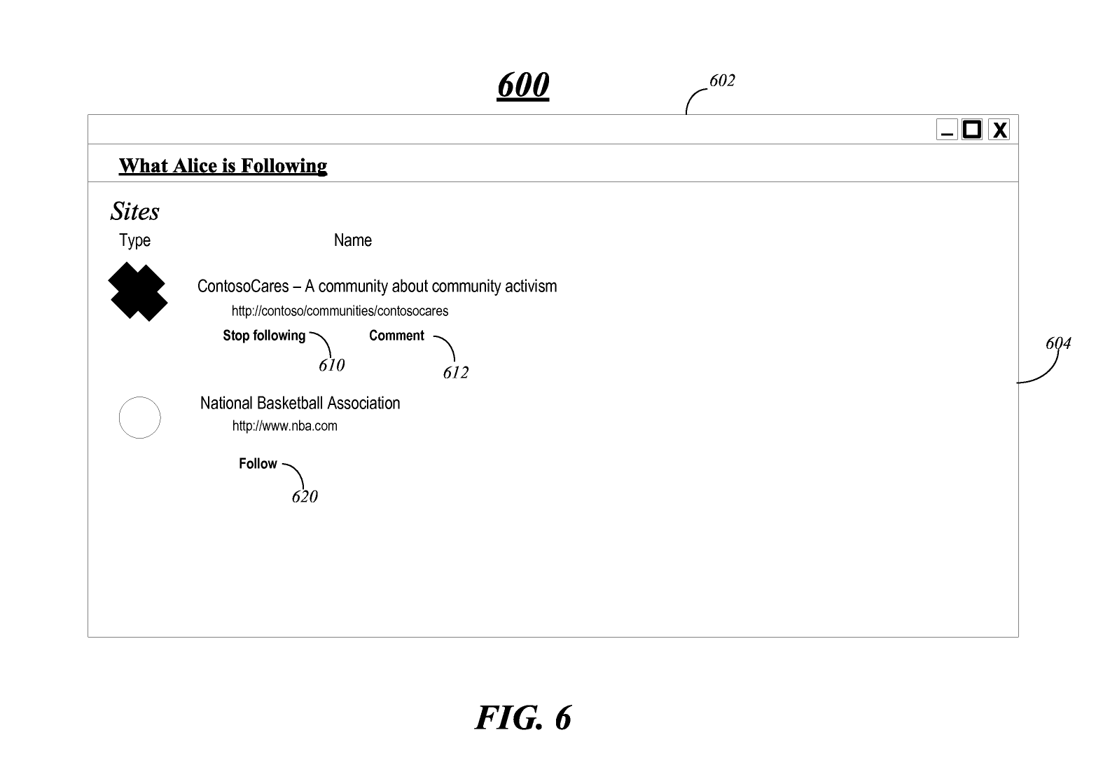

FIG. 6 illustrates an embodiment of a public collection view 600. Public collection view 600 may be an example of the view that one user has of another user's followed content. Public collection view 600 may be what appears when a user selects a person, e.g. when the user follows the reference to that person, from within the user's collection view. Public collection view 600 may be similar to a user's collection view. In some embodiments, public collection view 600 may have fewer functions available to the viewing user. For example, public collection view 600 may optionally hide information about when a content item was followed. In some embodiments the location or address of a content item may be hidden. In some embodiments, content items subject to limited access due to security or privacy policies may not be published in a public collection view, even when a following user has not explicitly indicated that the content item should not be published. Public collection view 600 may provide both an indication to the viewing user about whether a content item is also being followed by the viewing user, and the option to start or stop following the content item directly from the public collection view. For example, when a content item is already being followed, a stop following option 610 may simultaneously indicate following and provide the option to stop. Similarly, follow option 620 may simultaneously indicate that the content item is not followed by the viewing user, and provide the option to start. When a content item is already being followed, additional operations may be available, such as the option to comment 612 on the content item. In an embodiment, the followed status may be indicated separately from the options to follow or stop following, for example, with an icon or label. The embodiments are not limited to these examples.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

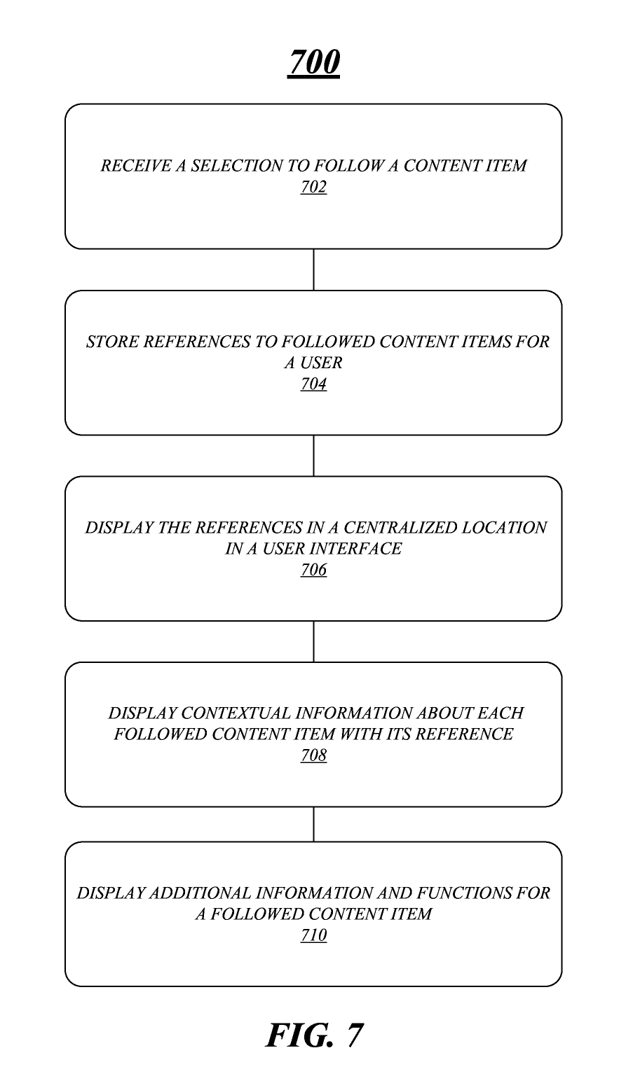

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may receive a selection to follow a content item at block 702. For example, collection manager 110, 200 may receive an indication that a user has made a follow selection in relation to a content item. The selection may be in the form of a user interface command directive, such as selecting a menu option, pressing a button, selecting a check-box, and so forth, in relation to a content item. The selection may be made under various circumstances. For example, the content item may be open and the user may select a menu option, contextual menu option or other interface selection mechanisms from within the viewing application. In other circumstances, the content item may not be open. The selection may be made from within a collection view, e.g. from a public collection view, or from within a directory view, for example, as part of a contextual menu for a stored content item. The embodiments are not limited to these examples.

The logic flow 700 may store a reference to the followed content item for a user at block 704. For example, collection builder 210 may generate a reference comprising a title, name or brief description of the content item, a date followed, a type, a location, and a selectable link that, when selected, causes the content item to be opened in the relevant application. Other contextual information may also be included in the reference. The reference may be stored for the user, for example, in a user collection 220.

The logic flow 700 may display the references in a centralized location in a user interface at block 706. For example, collection user interface 240 may retrieve the user collection for a user and may display the references in the collection in a collection view. The stored reference, and user collection, may be indexed to the user, via user identifying information, for example, in a user account 130. The user may identify himself to system 100 via the user account information, e.g. a username and password. Once identified, collection manager 110, 200 may retrieve only the references for that identified user. In an embodiment, the user may be able to access his collection from any client device that can communicate with collection manger 110, 200.

The logic flow 700 may display contextual information about each followed content item with its reference at block 708. For example, collection UI 240 may display the type, name, location, date followed and any other contextual information in the reference with a selectable link to open the content item.

In an embodiment, when a content item is modified, information about that modification may be stored in a cache. When collection UI 240 prepares to display contextual information about a content item, collection UI 240 may check the cache and retrieve any information about the content item that may be stored in the cache. For example, collection UI 240 may retrieve information that the content item was modified on a particular date, by a particular user. The information about modifications may or may not be displayed as part of the contextual information.

The logic flow 700 may display additional information functions for a followed content item at block 710. In an embodiment, the additional information and functions may be displayed when a selector is detected in proximity to a reference. For example, when a mouse cursor is hovered near or over a reference for a period of time, e.g. 1 second, additional information may be displayed. In an embodiment, the additional information and functions may be displayed when a contextual menu is opened for a reference, for example, by right-clicking a reference. A call-out window may open with the additional information, or the reference display area may expand to show the additional information. The additional information may include, for example, the modification information retrieved from the cache, comments, a preview, and a conversation. Additional functions may include, for example, opening the content item, managing notifications about the content item, starting a conversation, adding a comment to a conversation about the content item, filtering what additional functions to display, and sharing the content item with others.

Embodiments may further perform sorting and filtering operations on the displayed references. Sorting and filtering may be performed on any of title, type, date followed, a date modified, an author, an editor, and a commenter, or any combination thereof.

Embodiments may further provide a public collection view of a user's collection, from which selections to follow or stop following content items may be received.

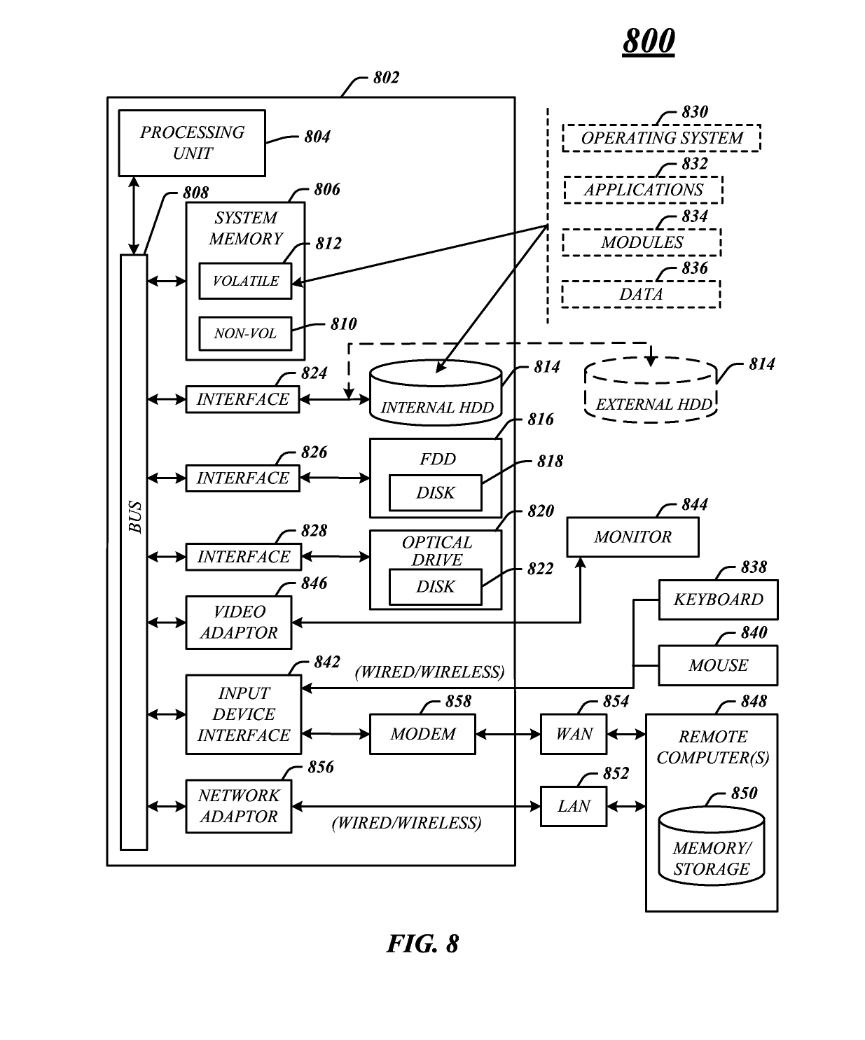

FIG. 8 illustrates an embodiment of an exemplary computing architecture 800 suitable for implementing various embodiments as previously described. The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors. Dual microprocessors and other multi-processor architectures may also be employed as the processing unit 804. The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures.

The system memory 806 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. The one or more application programs 832, other program modules 834, and program data 836 can include, for example, the collection manager 110, collection builder 210, and collection UI 240.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

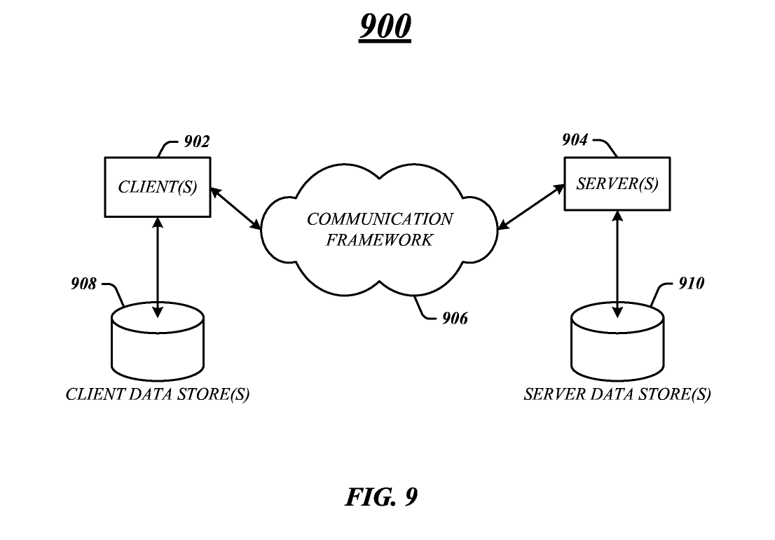

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement a client device 150. The servers 904 may implement a server system on which collection manager 110 operates. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving a selection to follow a content item;
storing references to followed content items for a user;
displaying the references in a centralized location in a user interface;
displaying contextual information about each followed content item with its reference; and
displaying additional information and functions for a followed content item in response to a received selection for additional information.

2. The method of claim 1, wherein the followed content items for a user comprise content items of different types.

3. The method of claim 2, wherein a type of a content item comprises at least one of:
a word processing document, a spreadsheet document, a presentation document, a web site, a uniform resource locator (URL), a real simple syndication (RSS) feed, a calendar event, a task, a discussion thread, a discussion board, a library of content items, a list of content items, a directory, a media file, and a network site.

4. The method of claim 1, wherein displaying contextual information about a followed content item comprises displaying at least one of: an icon, a title, a type, a date followed, a date modified, an address, a location, a keyword, an author, an editor, and a commenter.

5. The method of claim 4, further comprising at least one of:
sorting the displayed references according to at least one of: title, type, date followed, date modified, author, editor, and commenter; and
filtering the displayed references according to at least one of: title, type, date followed, date modified, keyword, author, editor, and commenter

6. The method of claim 1, further comprising:
opening a content item when a reference to the content item is selected.

7. The method of claim 1, wherein displaying additional information comprises displaying at least one of: a preview, a modification notice, an edit date, an editor, a commenter, and a conversation.

8. The method of claim 1, wherein displaying additional functions comprises displaying a selectable option for at least one of: opening the content item, managing notifications about the content item, starting a conversation, adding a comment to a conversation about the content item, filtering what additional functions to display, and sharing the content item with others.

9. The method of claim 1, further comprising:
storing information about a modification of a followed content item in a cache;
at least one of: fetching the stored information, and fetching additional information from the followed content item, when a reference to the followed content item is displayed; and
displaying at least one of the fetched stored information and the fetched additional information with the additional information and functions for a followed content item.

10. An article comprising a storage medium containing instructions that when executed cause a system to:
store references to followed content items for a user;
display the references in a centralized location in a user interface;
display contextual information about each followed content item with its reference; and
display additional information and functions for a followed content item in response to a received selection for additional information.

11. The article of claim 10, wherein the followed content items for a user comprise content items of different types, the types comprising at least one of: a word processing document, a spreadsheet document, a presentation document, a web site, a uniform resource locator (URL), a real simple syndication (RSS) feed, a calendar event, a task, a discussion thread, a discussion board, a library of content items, a list of content items, a directory, a media file, and a network site.

12. The article of claim 10, further comprising instructions that when executed cause the system to:
display contextual information about a followed content item including at least one of: an icon, a title, a type, a date followed, a date modified, an address, a location, a keyword, an author, an editor, and a commenter; and
sort the displayed references according to at least one of: title, type, date followed, a date modified, an author, an editor, and a commenter.

13. The article of claim 10, further comprising instructions that when executed cause the system to publish the references stored by one user to other users.

14. The article of claim 10, further comprising instructions that when executed cause the system to at least one of:
display additional information comprising at least one of: a preview, a modification notice, an edit date, and a conversation; and.
display a selectable option for at least one of: opening the content item, managing notifications about the content item, starting a conversation, adding a comment to a conversation about the content item, filtering what additional functions to display, and sharing the content item with others.

15. The article of claim 10, further comprising instructions that when executed cause the system to:
store information about a modification of a followed content item in a cache;
at least one of: fetch the stored information, and fetch additional information from the followed content item, when a reference to the followed content item is displayed; and
display at least one of the fetched stored information and the fetched additional information with the additional information and functions for a followed content item.

16. An apparatus, comprising:
a processing unit;
a memory communicatively coupled to the processing unit;
a collection manager operative on the processing unit to:
store references to followed content items for a user in the memory;
display the references in a centralized location in a user interface;
display contextual information about each followed content item with its reference; and
display additional information and functions for a followed content item in response to a received selection for additional information.

17. The apparatus of claim 16, the collection manager further operative to:
receive the selection for additional information when a selector is detected in proximity to a reference for the followed content item.

18. The apparatus of claim 16, the collection manager further operative to
display contextual information about a followed content item including at least one of: an icon, a title, a type, a date followed, a date modified, an address, a location, a keyword, an author, an editor, and a commenter;
sort the displayed references according to at least one of: title, type, date followed, a date modified, an author, an editor, and a commenter; and
filter the displayed references according to at least one of: title, type, date followed, date modified, keyword, location, author, editor, and commenter.

19. The apparatus of claim 16, the collection manager further operative to:
at least one of: fetch the stored information, and fetch additional information from the followed content item, when a reference to the followed content item is displayed; and
display at least one of the fetched stored information and the fetched additional information with the additional information and functions for a followed content item.

20. The apparatus of claim 16, the collection manager further operative to:
display additional information comprising at least one of: a preview, a modification notice, an edit date, and a conversation; and.
display a selectable option for at least one of: opening the content item, managing notifications about the content item, starting a conversation, adding a comment to a conversation about the content item, filtering what additional functions to display, and sharing the content item with others.
